(19) United States
(12) Patent Application Publication
(10) Pub. No.: US 2009/0226711 A1
(43) Pub. Date: Sep. 10, 2009

(54) Biaxially Oriented Nanocomposite Film, Method of Manufacture, and Articles Thereof

(75) Inventors: Norberto Silvi, Clifton Park, NY (US); Mark Giammattei, Selkirk, NY (US); Patricia Chapman Irwin, Altamont, NY (US); Yang Cao, Niskayuna, NY (US); Daniel Qi Tan, Rexford, NY (US); Charles Mead, Queensbury, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC COMPANY, Schenectady, NY (US)

(21) Appl. No.: 12/043,546

(22) Filed: Mar. 6, 2008

(51) Int. Cl. B32B 27/20; B29C 49/08; B29C 70/00

(52) U.S. Cl. 428/331; 264/514; 428/411.1; 428/412; 428/419; 428/421; 428/423.1; 428/473.5; 428/474.4; 428/480; 428/500; 428/702; 428/441

(57) ABSTRACT

A method comprises mixing a nano-filler and a polymer composition to form a nanocomposite; extruding the nanocomposite as a melt through a spiral mandrel die to form a molten tube; expanding the tube biaxially by means of mechanical force and air pressure to form a bubble; and collapsing the bubble to form at least one sheet of a biaxially oriented nanocomposite film, wherein the biaxially oriented nanocomposite film has a breakdown strength of at least 300 V/micrometer.

### BACKGROUND OF THE INVENTION

This disclosure relates to biaxially oriented nanocomposite films, methods of manufacture thereof, and articles comprising the same.

Composite films containing a polymeric matrix and a filler stretched in the machine and cross-machine (transverse) directions are used in the manufacture of electronic articles, such as capacitors, sensors and batteries. The addition of small quantities of a filler having a large surface area to a polymer is intended to improve the dielectric properties of the film, such as breakdown strength and voltage endurance, among other properties. The stretching of films in two orthogonal directions is also known to improve the breakdown strength of the film compared to the non-oriented, or even uniaxially oriented film.

Whereas oriented un-filled polymer films (polymers containing no fillers) are commonly prepared by the biaxial stretching of the polymer in the horizontal and vertical directions using the so-called “blown film” process, the biaxial stretching of composite polymeric materials into relatively thin films using the blown film method has been challenging. Non-uniform flow of the melt through the extruder circular die, instability of the bubble formed by the injection of air into the softened material, the sensitivity of the stretching process to the presence of impurities in the composite material and/or extruder-die system, and non-uniform distribution of the filler into the polymer matrix are some of the challenges that have prevented biaxially oriented composite film materials prepared by blown film methods from becoming commercially available in the market.

In commercial applications such as spark plug caps for automobiles or DC-link capacitors utilized in high energy density power conversion applications, it is known that high breakdown strength and corona resistance can be achieved by dispersing fillers in a polymer matrix. However, this adversely affects mechanical properties such as impact strength and ductility of the composite polymeric material. It is desirable, therefore, to achieve high breakdown strength and corona resistance without degrading the mechanical properties of the nanocomposite film.

It is known also that non-oriented, or even uniaxially oriented, unfilled polypropylene films in impregnated power capacitors catastrophically fail in accelerated life tests. Studies of dielectric strength on the biaxially oriented film, on the other hand, showed that the dielectric strength of biaxially oriented film was higher than non-oriented film by at least a factor of two. Typically, the expansion ratio between the extruder die and blown film is such that the diameter of the blown film is about 1.5 to 10 times the die diameter. Extruder screw speed, film take-up speed, internal bubble air pressure, and cooling rate are process parameters that affect bubble geometry and therefore the final properties of the oriented non-filled blown film.

In general, an ongoing need exists in the electronics and automotive industries for new polymeric compositions and less costly methods of making biaxially oriented nanocomposite films having a combination of high dielectric constant, high breakdown strength, high temperature resistance and good mechanical properties. The current disclosure addresses this need.

### BRIEF DESCRIPTION OF THE INVENTION

Biaxially oriented nanocomposite films prepared by a blown film process are disclosed herein for use in electronic applications such as capacitors.

In one embodiment, a method comprises mixing a nano-filler and a polymer composition to form a nanocomposite; extruding the nanocomposite as a melt through a spiral mandrel die to form a molten tube; expanding the tube biaxially by means of mechanical force and air pressure to form a bubble; and collapsing the bubble to form at least one sheet of a biaxially oriented nanocomposite film, wherein the biaxially oriented nanocomposite film has a breakdown strength of at least 300 V/micrometer.

In another embodiment is disclosed a biaxially oriented nanocomposite film formed by a process comprising mixing a nano-filler and a polymer composition to form a nanocomposite; extruding the nanocomposite as a melt to form a molten tube; expanding the tube biaxially by means of mechanical force and air pressure to form a bubble; and collapsing the bubble to form at least one sheet of a biaxially oriented nanocomposite film, wherein the biaxially oriented nanocomposite film has a breakdown strength of at least 300 V/micrometer.

In another embodiment, an article comprises the disclosed biaxially oriented nanocomposite film.

### BRIEF DESCRIPTION OF THE DRAWINGS

In the figures like elements are numbered alike.

FIG. 1 is a schematic of an extruder apparatus for preparing a nanocomposite.

FIG. 2 is a schematic of a film blowing apparatus showing the biaxial expansion of the tube within an oven section.

FIG. 3 is a schematic of a film blowing apparatus showing the biaxial expansion of the tube as the tube emerges from the cooling ring.

FIG. 4 is a schematic of a film blowing apparatus wherein the nanocomposite is formed in the extruder linked to the film-blowing apparatus.

FIG. 5 is a bar graph showing the change in breakdown strength of a nanocomposite composition comprising silica and alumina nanoparticles compared to a control having no nano-filler.

FIG. 6 is a transmission electron micrograph showing the nano-filler morphology in a nanocomposite pellet sample extrudate that has not been biaxially oriented.

FIG. 7 is a transmission electron micrograph illustrating the nano-filler morphology in a biaxially oriented nanocomposite blown film.

### DETAILED DESCRIPTION OF THE INVENTION

Disclosed herein is a method of making a biaxially oriented blown nanocomposite film comprising a polymer composition and a nano-filler comprising nanoparticles. The blown films have a dielectric constant, breakdown strength, energy density, corona resistance, and mechanical properties such as impact strength, tensile strength and ductility that are comparable to or superior to blown films of the un-filled polymer composition (without the nanoparticles). The disclosed method produces thin nanocomposite films by biaxial orientation of the nano-filled polymer composition in the molten state. These films contain a relatively small amount, less than about 10 weight percent (wt %), of a filler of nanometer dimensions (nano-filler) uniformly dispersed into the polymer. The filler can be added to the polymer composition in a previous step or in the film-making step by using some type of mixing equipment such as extruders. The extruders used to disperse the filler into the polymer and/or to generate the nanocomposite melt to produce the film can be of the single- or twin-screw type.

Thus, a method of forming a biaxially oriented nanocomposite film comprises mixing a nano-filler and a polymer composition to form a nanocomposite; extruding the nanocomposite as a melt through a spiral mandrel die to form a molten tube; expanding the tube biaxially by means of mechanical force and air pressure to form a bubble; and collapsing the bubble to form at least one sheet of a biaxially oriented nanocomposite film; wherein the biaxially oriented nanocomposite film has a breakdown strength of at least 300 V/micrometer.

In the method disclosed herein a composite material comprising for example, polypropylene as the continuous phase and relatively small quantities of a high surface area silica filler as the dispersed phase, are formed into a film of relatively small thickness and good dielectric properties by biaxially stretching the film into two orthogonal directions. The blown nanocomposite film has a breakdown strength of at least 300 V/micrometer, more particularly at least 450 V/micrometer, even more particularly at least 500 V/micrometer, and most particularly at least 600 V/micrometer. The blown nanocomposite film also has an energy density of about 1 J/cm³ to about 10 J/cm³, making them attractive for electronic applications such as capacitors. Films of between 10 and 20 micrometers in thickness, showing no impurities or contamination, and having dielectric breakdown strengths as high as 800 V/micrometer have been prepared by the disclosed method.

A biaxially oriented nanocomposite film is formed by flowing the molten nanocomposite through an annular slit die (usually of the spiral-mandrel type) at constant rate to produce a tube of given diameter and relatively small wall thickness. In one embodiment, the tube is expanded biaxially in an oven above the spiral mandrel die. In this embodiment, a high-speed air ring, mounted on top of the die, blows air onto the molten tube to cool it. The tube solidifies as it exits the die. The cooled tube moves vertically upward and through an oven which reheats and softens the tube. As the tube softens, air at high pressure is injected into the tube to expand the tube in the horizontal (transverse) direction while at the same time a mechanical force is applied to the end of the tube to stretch it in the vertical (machine direction) to form a bubble. In another embodiment the tube is expanded biaxially as it emerges from the spiral mandrel die. In this embodiment, the molten tube exiting the spiral mandrel die is stretched in both directions by the application of air pressure and a vertical mechanical force without cooling the tube first. In either embodiment, the tube is stretched into a bubble in both horizontal and vertical directions, generating the desired biaxial orientation of the polymer chains and resulting in improved mechanical and dielectric properties of the film. In one embodiment the bubble is then flattened into two film sheets joined at the edges, which continues traveling upwards while cooling. The joined film sheets then passes through nip rolls after which the edges are slit off to produce two separated film sheets of relatively small thickness that are wound up onto spools. In another embodiment, the bubble is slit and opened up into a single film sheet.

In another embodiment, mixing is by means of a first extruder and extruding to form the molten tube is by means of a second extruder. In one embodiment, the nanocomposite is isolated as a solid from a first extruder. In one embodiment the nanocomposite is pumped in the form of a melt from a first extruder to a second extruder. In one embodiment mixing and extruding to form a molten tube are performed by an extruder linked to a film blowing apparatus. In one embodiment, expanding the tube biaxially occurs in an oven above the spiral mandrel die. In one embodiment, expanding the tube biaxially occurs as the tube emerges from the spiral mandrel die.

The bubble has a diameter greater than 1 times, more particularly greater than 4 times, even more particularly greater than 6 times, and even more particularly greater than 8 times the diameter of the spiral mandrel die.

The polymeric composition can be selected from a wide variety of thermoplastic polymers, blends of thermoplastic polymers, or blends of thermoplastic polymers with thermosetting polymers. The polymeric composition can comprise a homopolymer, a copolymer such as a star block copolymer, a graft copolymer, an alternating block copolymer or a random copolymer, ionomer, dendrimer, or a combination comprising at least one of the foregoing. The polymeric composition can also be a blend of polymers, copolymers, terpolymers, or the like, or a combination comprising at least one of the foregoing. In one embodiment the thermoplastic polymer has a glass transition temperature of greater than or equal to about 100° C. In one embodiment, the polymeric composition comprises a polypropylene.

Exemplary thermoplastic polymers that can be used in the polymeric composition include polyacetals, polyacrylics, polycarbonates, polyalkyds, polystyrenes, polyolefins, polyesters, polyamides, polyaramides, polyamideimides, polyarylates, polyurethanes, silicones, polyarylsulfones, polyethersulfones, polyphenylsulfones, polycarbonates, silicones, polycarbonate-polyorganosiloxanes, polyphenylene sulfides, polysulfones, polyimides, polyetherimides, polytetrafluoroethylenes, polyetherketones, polyether etherketones, polyether ketone ketones, polybenzoxazoles, polyoxadiazoles, polybenzothiazinophenothiazines, polybenzothiazoles, polypyrazinoquinoxal ines, polypyromellitim ides, polyquinoxalines, polybenzimidazoles, polyoxindoles, polyoxoi soindolines, polydioxoisoindolines, polytriazines, polypyridazines, polypiperazines, polypyridines, polypiperidines, polytriazoles, polypyrazoles, polycarboranes, polyoxabicyclononanes, polydibenzofurans, polyphthalides, polyacetals, polyanhydrides, polyvinyl ethers, polyvinyl thioethers, polyvinyl alcohols, polyvinyl ketones, polyvinyl halides, polyvinyl nitriles, polyvinyl esters, polysulfonates, polysulfides, polythioesters, polysulfones, polysulfonamides, polyureas, polyphosphazenes, polysilazanes, polypropylenes, polyethylenes, polyethylene terephthalates, polyvinylidene fluorides, polysiloxanes, or the like, or a combination comprising at least one of the foregoing thermoplastic polymers. Exemplary polymers are ULTEM®, a polyetherimide, or SILTEM®, a polyetherimide-polysiloxane copolymer, both commercially available from SABIC (formerly General Electric Plastics). More specifically, the thermoplastic polymer is polypropylene.

Still other thermoplastic polymers include fluorenyl polyester (FPE), polyvinylidene fluoride, polyvinylidine fluoride-trifluoroethylene P(VDF-TrFE), polyvinylidene-tetrafluoroethylene copolymers P(VDF-TFE), polyvinylidine trifluoroethylene hexafluoropropylene copolymers P(VDF-TFE-HFE) and polyvinylidine hexafluoropropylene copolymers P(VDF-HFE), cyanoresins, or a combination comprising at least one of the foregoing polymers.

Examples of blends of thermoplastic polymers include acrylonitrile-butadiene-styrene/nylon, polycarbonate/acrylonitrile-butadiene-styrene, polyphenylene ether/polystyrene, polyphenylene ether/polyamide, polycarbonate/polyester, polyphenylene ether/polyolefin, or the like, or a combination comprising at least one of the foregoing.

In another embodiment, thermosetting polymers can be blended with the thermoplastic polymers for use in the nanocomposite composition. Examples of thermosetting polymers are resins of epoxy/amine, epoxy/anhydride, isocyanate/amine, isocyanate/alcohol, unsaturated polyesters, vinyl esters, unsaturated polyester and vinyl ester blends, unsaturated polyester/urethane hybrid resins, polyurethane-ureas, reactive dicyclopentadiene (DCPD) resin, reactive polyamides, or the like, or a combination comprising at least one of the foregoing. An exemplary thermosetting polymer is NORYL® (TSN NORYL®), a polyphenylene ether, commercially available from SABIC.

In one embodiment, suitable thermosetting polymers include thermosetting polymers that can be made from an energy activatable thermosetting pre-polymer composition. Examples include polyurethanes such as urethane polyesters, silicone polymers, phenolic polymers, amino polymers, epoxy polymers, bismaleimides, polyimides, and furan polymers. The energy activatable thermosetting pre-polymer component can comprise a polymer precursor and a curing agent. The polymer precursor can be heat activatable, eliminating the need for a catalyst. The curing agent selected will not only determine the type of energy source needed to form the thermosetting polymer, but can also influence the resulting properties of the thermosetting polymer. Examples of curing agents include aliphatic amines, aromatic amines, acid anhydrides, or the like, or a combination comprising at least one of the foregoing. The energy activatable thermosetting pre-polymer composition can include a solvent or processing aid to lower the viscosity of the composition for ease of extrusion including higher throughputs and lower temperatures. The solvent could help retard the crosslinking reaction and could partially or totally evaporate during or after polymerization.

As noted above, it is desirable for the thermoplastic polymers to have a glass transition temperature of greater than or equal to about −30° C. In one embodiment, it is desirable for the thermoplastic polymers to have a glass transition temperature of greater than or equal to about −20° C. In another embodiment, it is desirable for the thermoplastic polymers to have a glass transition temperature of greater than or equal to about 0° C. In yet another embodiment, it is desirable for the thermoplastic polymers to have a glass transition temperature of greater than or equal to about 20° C. In yet another embodiment, it is desirable for the thermoplastic polymers to have a glass transition temperature of greater than or equal to about 100° C.

In one embodiment, the polymeric composition is used in an amount of about 5 to about 99.999 wt % of the total weight of the extruded melt composition. In another embodiment, the polymeric composition is used in an amount of about 40 wt % to about 99.99 wt % of the total weight of the extruded melt composition. In another embodiment, the polymeric composition is used in an amount of about 60 wt % to about 99.5 wt % of the total weight of the extruded melt composition. In another embodiment, the polymeric composition is used in an amount of about 80 wt % to about 99.3 wt % of the total weight of the extruded melt composition.

The melt composition also comprises a nano-filler comprising nanoparticles. Nano-fillers include inorganic oxides such as metal oxides of alkali earth metals, alkaline earth metals, transition metals, metalloids, poor metals, or the like, or a combination comprising at least one of the foregoing. Exemplary inorganic oxides include cerium oxide (ceria), magnesium oxide (magnesia), titanium oxide (titania), zinc oxide, silicon oxide (e.g., silica and/or fumed silica), colloidal silica, dispersions of colloidal silica in solvent, precipitated silica, copper oxide, aluminum oxide (e.g., alumina and/or fumed alumina), calcium oxide (calcia), zirconium oxide (zirconia), niobium pentoxide (niobia), yttrium oxide (yttria), tantalum pentoxide (tantala), barium titanate, barium strontium titanate, strontium-doped lanthanum manganate, calcium copper titanate (CaCu₃Ti₄O₁₂), cadmium copper titanate (CdCu₃Ti₄O₁₂), lanthanum doped CaMnO₃, and (Li, Ti) doped NiO, or a combination comprising at least one of the foregoing. In one embodiment, the polymer composition comprises polypropylene and the nano-filler comprises fumed silica.

Commercially available examples of fillers comprising nanosized inorganic oxides are NANOACTIVE® calcium oxide, NANOACTIVE® calcium oxide plus, NANOACTIVE® cerium oxide, NANOACTIVE® magnesium oxide, NANOACTIVE® magnesium oxide plus, NANOACTIVE® titanium oxide, NANOACTIVE® zinc oxide, NANOACTIVE® silicon oxide, NANOACTIVE® copper oxide, NANOACTIVE® aluminum oxide, NANOACTIVE® aluminum oxide plus, all commercially available from NanoScale Materials Incorporated.

The nano-filler comprises nano-particles having an average particle size in one dimension of 1 nanometer to 100 nanometers, more particularly 1 nanometer to 50 nanometers, and most particularly 1 nanometer to 10 nanometers. The aggregates formed by the nano-particles comprise at least two nano-particles and have a size in one characteristic dimension of 2 nanometers to 1000 nanometers, more particularly 2 nanometers to 500 nanometers, even more particularly 2 nanometers to 300 nanometers and most particularly 2 nanometers to 200 nanometers. The characteristic dimension can be a diameter, edge of a face, length of a rod, thickness of a platelet or the like.

The nano-filler can be surface treated to enhance dispersion within the polymeric composition. The surface treatment can comprise coating the nanoparticles with an organic material such as a silane. In one embodiment, the surface treatment comprises coating the nanoparticles with a silane-coupling agent. Examples of silane-coupling agents include tetramethylchlorosilane, hexadimethylenedisilazane, gamma-aminopropoxysilane, or the like, or a combination comprising at least one of the foregoing silane-coupling agents. The silane-coupling agents generally enhance compatibility of the nanoparticles with the polymeric composition and improve dispersion of the nanoparticles within the polymeric composition.

The nanoparticles can be surface treated by coating with a polymer or a monomer such as, for example, spray drying a dispersion of nanoparticle and polymer solution, co-polymerization on the nanoparticle surface, and melt spinning followed by milling. In one method of surface treatment the nanoparticles are suspended in a solvent, such as, for example demineralized water and the suspension's pH is measured. The pH can be adjusted and stabilized with small addition of acid (e.g., acetic acid or dilute nitric acid) or base (e.g., ammonium hydroxide or dilute sodium hydroxide). The pH adjustment produces a charged state on the surface of the nanoparticle. Once a desired pH has been achieved, a coating material (for example, a polymer or other appropriate precursor) with opposite charge is introduced into the solvent. The coating material is coupled around the nanoparticle to provide a coating layer around the nanoparticle. Once the coating layer has formed, the nanoparticle isolated from the solvent by drying, filtration, centrifugation, or another method appropriate for solid-liquid separation. This technique of coating a nanoparticle with another material using surface charge can be used for a variety of nanocomposite compositions.

When a solvent is used to apply a surface coating to the nanoparticles, as in the coating method described above, the polymeric composition can also be dissolved in the solvent and a nanocomposite composition formed by removing the solvent.

The nanoparticles can have shapes whose dimensionalities are defined by integers, e.g., the nanoparticles are 1, 2 or 3-dimensional in shape. They can also have shapes whose dimensionalities are not defined by integers (e.g., they can exist in the form of fractals). The nanoparticles can exist in the form of spheres, rods, tabular grains, flakes, fibers, whiskers, or the like, or a combination comprising at least one of the foregoing forms. The nanoparticles can have cross-sectional geometries that can be circular, ellipsoidal, triangular, rectangular, polygonal, or a combination comprising at least one of the foregoing geometries. The nanoparticles, as commercially available, can exist in the form of aggregates or agglomerates prior to incorporation into the polymeric composition or even after incorporation into the polymeric composition. An aggregate comprises more than one nanoparticle in physical contact with one another, while an agglomerate comprises more than one aggregate in physical contact with one another.

Regardless of the exact size, shape and composition of the nanoparticles, the nano-filler can be dispersed into the polymeric composition at loadings of 0.1 to 50.0 wt % (weight percent), more particularly 0.1 to 20.0 wt %, even more particularly 1.0 to 10.0 wt %, and most particularly 1.0 to 8.0 wt % based on total weight of the nanocomposite composition. In one embodiment, the nanoparticles are present in an amount of greater than or equal to about 1.0 wt % of the total weight of the nanocomposite composition. In another embodiment, the nanoparticles are present in an amount of greater than or equal to about 3.0 wt % of the total weight of the nanocomposite composition. In another embodiment, the nanoparticles are present in an amount of greater than or equal to about 6.0 wt % of the total weight of the melt composition.

The nanocomposite composition can further comprise optional additives with the proviso that the important properties are not adversely affected by the additive, for example mechanical strength, dielectric constant, and breakdown strength. Exemplary additives include antioxidants, fillers and reinforcing agents other than nano-fillers, such as, for example, fibers, glass fibers (including continuous and chopped fibers), carbon black, graphite, calcium carbonate, talc, mica and other additives such as, for example, mold release agents, UV absorbers, heat and light stabilizers, lubricants, plasticizers, pigments, dyes, colorants, anti-static agents, blowing agents, flame retardants, impact modifiers, among others.

Exemplary antioxidants include, for example, organophosphites, for example, tris(nonyl-phenyl)phosphite, tris(2,4-di-t-butylphenyl)phosphite, bis(2,4-di-t-butylphenyl)pentaerythritol diphosphite or distearyl pentaerythritol diphosphite, alkylated monophenols, polyphenols and alkylated reaction products of polyphenols with dienes, such as, for example, tetrakis[methylene(3,5-di-tert-butyl-4-hydroxyhydrocinnamate)]methane, 3,5-di-tert-butyl-4-hydroxyhydrocinnamate octadecyl, 2,4-di-tert-butylphenyl phosphite, butylated reaction products of para-cresol and dicyclopentadiene, alkylated hydroquinones, hydroxylated thiodiphenyl ethers, alkylidene-bisphenols, benzyl compounds, esters of beta-(3,5-di-tert-butyl-4-hydroxyphenyl)-propionic acid with monohydric or polyhydric alcohols, esters of beta-(5-tert-butyl-4-hydroxy-3-methylphenyl)-propionic acid with monohydric or polyhydric alcohols; esters of thioalkyl or thioaryl compounds, such as, for example, distearylthiopropionate, dilaurylthiopropionate, ditridecylthiodipropionate, amides of beta-(3,5-di-tert-butyl-4-hydroxyphenyl)-propionic acid, or a combination comprising at least one of the foregoing antioxidants. When present, the antioxidants are used in an amount of 0.0001 wt. % to 2 wt. %, more specifically 0.01 wt. % to 1.2% wt. %, based on the total weight of the thermoplastic composition.

Examples of the aforementioned heat stabilizers, include, but are not limited to, phenol stabilizers, organic thioether stabilizers, organic phosphite stabilizers, hindered amine stabilizers, epoxy stabilizers and mixtures thereof. The heat stabilizer can be added in the form of a solid or liquid.

Examples of the mold-release agents include, but are not limited to natural and synthetic paraffins, polyethylene waxes, fluorocarbons, and other hydrocarbon mold-release agents; stearic acid, hydroxystearic acid, and other higher fatty acids, hydroxyfatty acids, and other fatty acid mold-release agents; stearic acid amide, ethylene bis-stearamide, and other fatty acid amides, alkylene bis-fatty acid amides, and other fatty acid amide mold-release agents; stearyl alcohol, cetyl alcohol, and other aliphatic alcohols, polyhydric alcohols, polyglycols, polyglycerols and other alcoholic mold release agents; butyl stearate, pentaerythritol tetrastearate, and other lower alcohol esters of fatty acids, polyhydric alcohol esters of fatty acids, polyglycol esters of fatty acids, and other fatty acid ester mold release agents; silicone oil and other silicone mold release agents, and mixtures of any of the aforementioned.

The coloring agent can be either pigments or dyes. Inorganic coloring agents and organic coloring agents can be used separately or in combination. Exemplary dyes include, for example, organic dyes such as coumarin 460 (blue), coumarin 6 (green), nile red or the like; lanthanide complexes; hydrocarbon and substituted hydrocarbon dyes; polycyclic aromatic hyrdocarbons; scintillation dyes (preferably oxazoles and oxadiazoles); aryl- or heteroaryl-substituted poly (2-8 olefins); carbocyanine dyes; phthalocyanine dyes and pigments; oxazine dyes; carbostyryl dyes; porphyrin dyes; acridine dyes; anthraquinone dyes; arylmethane dyes; azo dyes; diazonium dyes; nitro dyes; quinone imine dyes; tetrazolium dyes; thiazole dyes; perylene dyes, perinone dyes; bis-benzoxazolylthiophene (BBOT); and xanthene dyes; fluoropliores such as anti-stokes shift dyes which absorb in the near infrared wavelength and emit in the visible wavelength, or the like; luminescent dyes such as 5-amino-9-diethyliminobenzo(a)phenoxazonium perchlorate; 7-amino-4-methylcarbostyryl; 7-amino-4-methylcoumarin; 7-amino-4-trifluoromethylcoumarin; 3-(2′-benzimidazolyl)-7-N,N-diethylaminocoumarin; 3-(2′-benzothiazolyl)-7-diethylaminocoumarin; 2-(4-biphenylyl)-5-(4-t-butylphenyl)-1,3,4-oxadiazole; 2-(4-biphenylyl)-5-phenyl-1,3,4-oxadiazole; 2-(4-biphenyl)-6-phenylbenzoxazole-1,3; 2,5-Bis-(4-biphenylyl)-1,3,4-oxadiazole; 2,5-bis-(4-biphenylyl)-oxazole; 4,4′-bis-(2-butyloctyloxy)-p-quaterphenyl; p-bis(o-methylstyryl)-benzene; 5,9-diaminobenzo(a)phenoxazonium perchlorate; 4-dicyanomethylene-2-methyl-6-(p-dimethylaminostyryl)-4H-pyran; 1,1′-diethyl-2,2′-carbocyanine iodide; 1,1′-diethyl-4,4′-carbocyanine iodide; 3,3′-diethyl-4,4′,5,5′-dibenzothiatricarbocyanine iodide; 1,1′-diethyl-4,4′-dicarbocyanine iodide; 1,1′-diethyl-2,2′-dicarbocyanine iodide; 3,3′-diethyl-9,11-neopentylenethiatricarbocyanine iodide; 1,3′-diethyl-4,2′-quinolyloxacarbocyanine iodide; 1,3′-diethyl-4,2′-quinolylthiacarbocyanine iodide; 3-diethylamino-7-diethyliminophenoxazonium perchlorate; 7-diethylamino-4-methylcoumarin; 7-diethylamino-4-trifluoromethylcoumarin; 7-diethylaminocoumarin; 3,3′-diethyloxadicarbocyanine iodide; 3,3′-diethylthiacarbocyanine iodide; 3,3′-diethylthiadicarbocyanine iodide; 3,3′-diethylthiatricarbocyanine iodide; 4,6-dimethyl-7-ethylaminocoumarin; 2,2′-dimethyl-p-quaterphenyl; 2,2-dimethyl-p-terphenyl; 7-dimethylamino-1-methyl-4-methoxy-8-azaquinolone-2; 7-dimethylamino-4-methylquinolone-2; 7-dimethylamino-4-trifluoromethylcoumarin; 2-(4-(4-dimethylaminophenyl)-1,3-butadienyl)-3-ethylbenzothiazolium perchlorate; 2-(6-(p-dimethylaminophenyl)-2,4-neopentylene-1,3,5-hexatrienyl)-3-methylbenzothiazolium perchlorate; 2-(4-(p-dimethylaminophenyl)-1,3-butadienyl)-1,3,3-trimethyl-3H-indolium perchlorate; 3,3′-dimethyloxatricarbocyanine iodide; 2,5-diphenylfuran; 2,5-diphenyloxazole; 4,4′-diphenylstilbene; 1-ethyl-4-(4-(p-dimethylaminophenyl)-1,3-butadienyl)-pyridinium perchlorate; 1-ethyl-2-(4-(p-dimethylaminophenyl)-1,3-butadienyl)-pyridinium perchlorate; 1-Ethyl-4-(4-(p-dimethylaminophenyl)-1,3-butadienyl)-quinolium perchlorate; 3-ethylamino-7-ethylimino-2,8-dimethylphenoxazin-5-ium perchlorate; 9-ethylamino-5-ethylamino-10-methyl-5H-benzo(a)phenoxazonium perchlorate; 7-ethylamino-6-methyl-4-trifluoromethylcoumarin; 7-ethylamino-4-trifluoromethylcoumarin; 1,1′,3,3,3′,3′-hexamethyl-4,4′,5,5′-dibenzo-2,2′-indotricarboccyanine iodide; 1,1′,3,3,3′,3′-hexamethylindodicarbocyanine iodide; 1,1′,3,3,3′,3′-hexamethylindotricarbocyanine iodide; 2-methyl-5-t-butyl-p-quaterphenyl; N-methyl-4-trifluoromethylpiperidino-<3,2-g>coumarin; 3-(2′-N-methylbenzimidazolyl)-7-N,N-diethylaminocoumarin; 2-(1-naphthyl)-5-phenyloxazole; 2,2′-p-phenylen-bis(5-phenyloxazole); 3,5,3″″,5″″-tetra-t-butyl-p-sexiphenyl; 3,5,3″″,5″″-tetra-t-butyl-p-quinquephenyl; 2,3,5,6-1H,4H-tetrahydro-9-acetylquinolizino-<9,9a,1-gh>coumarin; 2,3,5,6-1H,4H-tetrahydro-9-carboethoxyquinolizino-<9,9a,1-gh>coumarin; 2,3,5,6-1H,4H-tetrahydro-8-methylquinolizino-<9,9a,1-gh>coumarin; 2,3,5,6-1H,4H-tetrahydro-9-(3-pyridyl)-quinolizino-<9,9a, 1-gh>coumarin; 2,3,5,6-1H,4H-tetrahydro-8-trifluoromethylquinolizino-<9,9a, 1-gh>coumarin; 2,3,5,6-1H,4H-tetrahydroquinolizino-<9,9a, 1-gh>coumarin; 3,3′,2′,3′″-tetramethyl-p-quaterphenyl; 2,5,2′,2″,3′″-tetramethyl-p-quinquephenyl; P-terphenyl; P-quaterphenyl; nile red; rhodamine 700; oxazine 750; rhodamine 800; IR 125; IR 144; IR 140; IR 132; IR 26; IR5; diphenylhexatriene; diphenylbutadiene; tetraphenylbutadiene; naphthalene; anthracene; 9,10-diphenylanthracene; pyrene; chrysene; rubrene; coronene; phenanthrene or the like, or combinations comprising at least one of the foregoing dyes.

Other colorants include, for example titanium dioxide, anthraquinones, perylenes, perinones, indanthrones, quinacridones, xanthenes, oxazines, oxazolines, thioxanthenes, indigoids, thioindigoids, naphtalimides, cyanines, xanthenes, methines, lactones, coumarins, bis-benzoxaxolylthiophenes (BBOT), napthalenetetracarboxylic derivatives, monoazo and disazo pigments, triarylmethanes, aminoketones, bis(styryl)biphenyl derivatives, and the like, as well as combinations comprising at least one of the foregoing colorants.

When present, a colorant is used in an amount of 0.001 to 2 parts by weight, based on 100 parts by weight of the polyester.

Exemplary antistatic agents include, for example, glycerol monostearate, sodium stearyl sulfonate, sodium dodecylbenzenesulfonate or the like, or combinations of the foregoing antistatic agents. Carbon fibers, carbon nanofibers, carbon nanotubes, carbon black or a combination of the foregoing can be used in a polymeric resin containing chemical antistatic agents to render the composition electrostatically dissipative.

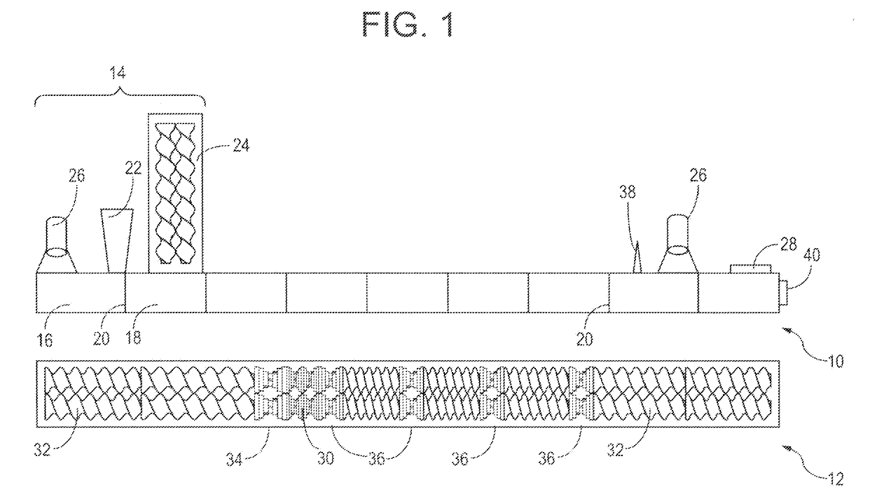

The first step in forming a biaxially oriented nanocomposite film is mixing a nano-filler and a polymer composition to form a nanocomposite. This can be accomplished using a first extruder 10 schematically represented as in FIG. 1. First extruder 10 can comprise a single screw or multiple screws, more particularly twin screws as shown in screw diagram 12 of FIG. 1. The twin screws can be intermeshing co-rotating or counter rotating screws, non-intermeshing co-rotating or counter rotating screws, reciprocating screws, screws with pins, barrels with pins, rolls, rams, helical rotors, or a combination comprising at least one of the foregoing. The extruder 10 further comprises six or more sequentially arranged barrels of equal length, more particularly eight or more barrels, and even more particularly nine or more barrels indicated by barrel one 16, and barrel two 18 in FIG. 1 (other barrels not labeled). The segmentations 20 along the extruder 10 indicate the transitions from one extruder barrel to the next. Each barrel can comprise one or more screw types, and therefore the individual screw lengths in screw diagram 12 do not coincide with barrel lengths in FIG. 1. The polymer composition is supplied to barrel one 16 via hopper 22. The nano-filler composition and any other optional additives are supplied to barrel two 18 via side feeder 24. The extruder further comprises one or more atmospheric vents 26. In one embodiment the polymer composition and/or the nano-filler are supplied to the extruder 10 in the form of a pellet, powder, fiber, sphere, flake, whisker, or a combination comprising at least one of the foregoing forms.

The polymeric composition and the nano-filler, and any other optional additives, are mixed in the first extruder 10 to form the nanocomposite. The first extruder is operated at a temperature between about 100° C. and about 400° C., more particularly of about 120° C. to about 300° C., at a screw speed of about 50 to about 1200 rpm, more particularly about 100 to about 800 rpm, and a torque of 10% to 100%, more particularly 20 to 80%. The first extruder screw design consists of conveying screw elements illustrated by 32 and mixing sections which include an initial mixing section 34 and four or more zones of intense mixing 36. The first extruder 10 is equipped with one or more atmospheric vents 26 that can be further connected to a manifold (not shown) for removal of solvents and/or other volatile materials within the first extruder.

The downstream atmospheric vent 26 is positioned having at least one kneading block 30 interposed between the feed inlet zone 14 and the atmospheric vent 26. This interposition of the kneading block 30 between the feed inlet zone and the atmospheric vent 26 serves to prevent entrainment of solids out through the atmospheric vent 26. Optionally, the first extruder 10 can be equipped with zero to four vacuum vents 38. In this instance, the extruder screws are sealed to prevent atmospheric venting. Here again, a kneading block 30 (typically the “left-handed” type) is interposed between the feed inlet zone 14 and the vacuum vents 38 in order to prevent the entrainment of solids by the rapidly escaping vapors. Vacuum vents 38 are located over conveying elements 32 to minimize the movement of polymer into the vents.

Additionally, the first extruder 10 can be equipped with one or more sensors 28 which can be used to monitor melt temperature, die pressure, torque or other system parameters which in turn can be used as when operating the system according to a closed loop control strategy. Extruder 10 can also comprise a die plate 40 through which the molten nanocomposite is extruded for subsequent cooling and pelletizing, or other operation.

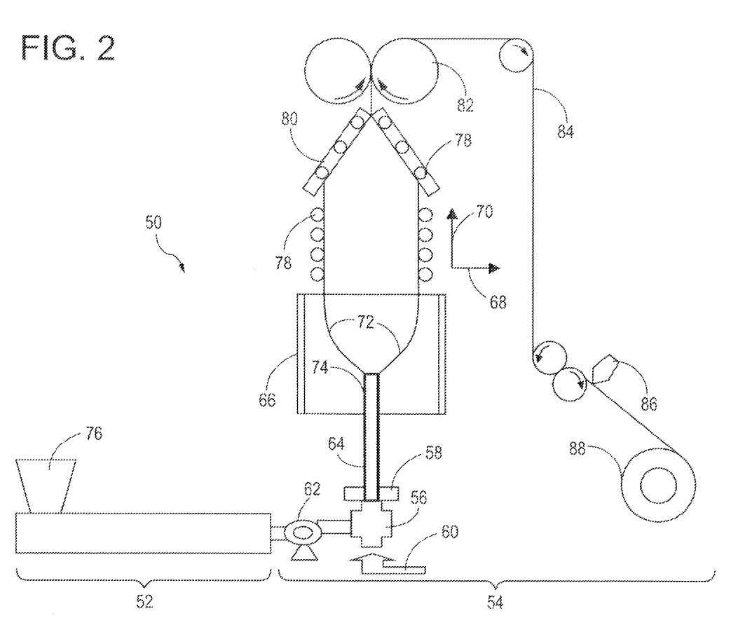

It is generally desirable during the mixing step to impart a specific energy of about 0.01 to about 10 kilowatt-hour/kilogram (kwhr/kg) of the composition. Within this range, a specific energy of greater than or equal to about 0.05, more particularly greater than or equal to about 0.08, and even more particularly greater than or equal to about 0.09 kwhr/kg is generally desirable for blending the polymer composition with the nano-filler. Also desirable is an amount of specific energy less than or equal to about 9, more particularly less than or equal to about 8, and even more particularly less than or equal to about 7 kwhr/kg for blending the polymer composition with the filler. In one embodiment the nanocomposite is prepared in a first extruder and is extruded from a second extruder 52 attached to a film blowing apparatus 54, as depicted schematically by system 50 in FIG. 2. The second extruder 52 can further comprise one or more barrels, atmospheric vents, vacuum vents, and sensors (not shown in FIG. 2). The molten nanocomposite prepared in the first extruder can be isolated as a solid, for example as pellets, flakes, and fibers, by methods well known in the art. The solid nanocomposite can then be introduced by any solid feeding mechanism 76, for example a hopper or side feeder, into second extruder 52 where it is then reheated to a molten state. Alternatively, a pump (not shown) attached to the first extruder is used to transfer the molten nanocomposite from the first extruder to second extruder 52. In one embodiment, the first extruder and second extruder comprise single or twin screws. In one embodiment, the first extruder comprises twin screws and the second extruder comprises a single screw.

In the next step of the process of making a blown biaxially oriented nanocomposite film, the molten nanocomposite is extruded to form a molten tube. As shown in FIG. 2, pump 62 forces molten nanocomposite emerging from extruder 52 through spiral mandrel die 56 of circular cross-section to form a molten tube. Spiral mandrel die 56 comprises a coaxially disposed outer ring and an inner mandrel (not shown) which have a small gap, typically about 1 to 3 millimeters between the outer ring and the inner mandrel. Additionally, spiral mandrel die 56 utilizes two independent air streams (shown generally in FIG. 2 as air jet 60), the first of which flows upwardly from the center of the inner mandrel and the second of which flows generally upward and slightly inward from just beyond the exterior of the outer ring using an air ring, not shown. In one embodiment the molten tube emerging from spiral mandrel die 56 is cooled by cooling ring 58 to form a rigid tube 64 which is forced upward into radiant oven 66. Radiant oven 66 heats and softens rigid tube 64 to form softened tube 74. Softened tube 74 is then expanded in both the transverse direction 68 and machine direction 70 using a combination of air jet 60 and mechanical pulling, resulting in bubble 72 comprising biaxially oriented nanocomposite. The spiral mandrel die parameters can range from greater than 1:1 BUR (Blown Up Ratio) to about 1:10 BUR, and preferably, more particularly about 1:8 BUR in the cross web direction. In the length (or machine) direction, die parameters can range from about 1:1 draw down ratio to about 1:300 draw down ratio, and more particularly, about 1:25 to 1:200 draw down ratio.

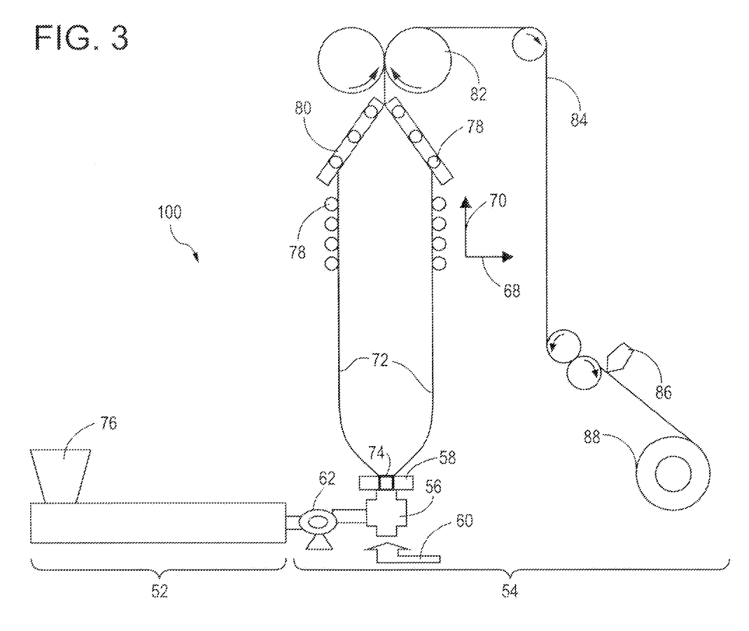

In another embodiment, generally shown as system 100 in FIG. 3, the temperature of cooling ring 58 is regulated to produce a softened nanocomposite tube 74 having the optimal bubble forming temperature when softened tube 74 emerges from cooling ring 58. Softened tube 74 is then expanding biaxially as described above to form bubble 72.

In the stretching process of FIG. 2 (or FIG. 3), the tube is pushed and pulled upward, the inner air flow used to provide sufficient air volume to inflate the tube into a bubble 72. Temperature and pressure are regulated by well known means to provide optimal conditions for formation of the bubble 72. Orienting temperatures depend on the polymer, but generally range from about 38° C. to about 82° C., and more particularly, about 60° C. The bubble 72 is also subjected to mechanical stretching in the machine direction 70. The bubble 72 can be pulled either up or down from the spiral mandrel die 56. In one embodiment the bubble 72 is pulled upward to facilitate control and maintenance of the melt temperature during orientation. Without being limited to or bound by theory, it is believed that the orienting process conveys strength and flexibility to the film product.

The nanocomposite melt viscosity can be adjusted by air cooling the die inner mandrel, the use of viscosity enhancers, liquid thermoregulation of the die, or a combination thereof. In some cases in order to maximize throughput, internal bubble cooling (IBC) is employed by circulating chilled air inside the bubble 72 to provide additional cooling. The outer air flow serves to cool the molten polymer and to provide an air curtain which helps to maintain a stable bubble 72 of the desired shape and diameter. In some cases an internal bubble stabilizer (IBS) is used to help control the bubble shape. An IBS can be generally be described as a tube located at the center of the spiral mandrel die extending upwards with an inverted cone shape on its end. Since bubble expansion occurs shortly after making contact with the IBS cone, the height of the IBS cone determines the neck height. Typically, the inner air pressure will generally be very slightly higher than atmospheric air pressure and as a result, it is possible to maintain a stable film bubble 72 which does not tend to collapse in on itself. In one embodiment the film bubble 72 travels upwardly guided by rollers 78 a distance of about 10 to 40 feet and is collapsed at its upper most end by a pair of nip rollers 82.

By controlling the take up rate, blow up ratio (using internal air pressure), throughput, and neck height (using outer air volume, temperature or velocity and IBS cone height), it is possible to adjust the amount of orientation imparted to the nanocomposite forming the bubble. Generally, bubbles which are formed at higher rates of speed will exhibit more orientation in the machine direction and, consequently, have higher tensile strength and elastic modulus in the axial or machine direction of the bubble and higher tear ratios (TD/MD tear ratio-transverse direction tear strength divided by the machine direction tear strength). By slightly increasing the internal pressure, it is possible to allow the bubble to expand to a greater diameter and impart higher hoop stresses or greater orientation in the transverse direction or about the circumference of the bubble. However, the amount of orientation which can be imparted to the nanocomposite is strongly correlated to the rheological properties of the nanocomposite melt.

One particularly critical property which is correlated to the rheological characteristics of the nanocomposite melt is film bubble stability. Studies on pilot plant polymers have shown that increasing the rheological breadth (properties such as melt volume flow rate and viscoelastic properties) produces more stable blown film bubbles. As noted earlier, bubble stability is a critical property in the production of blown films as film bubbles that tend to breathe, dance or shake will generally require the processor to slow the production line to address this issue or a loss of acceptable film product due to poor gauge distribution and/or properties could result. While operating the blown film line at slower speeds might correct film bubble stability issues, the slower speeds are detrimental to production efficiency.

As noted above, the bubble is collapsed or flattened to form at least one film sheet 84, FIG. 2. In one embodiment the bubble is collapsed to form two sheets joined at the edges. The collapsing process is performed by use of an “A-frame,” also known as a collapsing frame 80. This frame uses nip rollers, panels, and/or flat sticks to flatten the bubble 72 into a sheet of double-thickness film. In one embodiment, the collapsing frame can be enclosed by a heating oven (not shown) to control the temperature at which the bubble 72 is collapsed. The oven enclosure can optionally extend to and be sealed at or near the top of the bubble to better maintain insulation and temperature control. The heating oven can generally comprise any device that prevents the bubble from cooling below a predetermined temperature, and can include both heated panels and/or insulation alone. The oven comprises a heat source preferably located at or near the top of the collapsing frame 80. The heat generated is then maintained and circulated within the oven by virtue of insulation encompassing the bubble.

The connected sheets 84 can be slit at the edges using slitter 86 and separately wound onto take up rolls 88 or coils. It is possible to have alternative or additional processing steps, not shown, between the nip rollers 82 and the take up roll 88 including heat welding, perforation, corona treatment or the like. In another embodiment, the nipped bubble 84 is cut or slit along one side and opened out into a single biaxially-oriented sheet prior to winding on the take up roll. The sheets of film can also be cut to desired length.

The above described method of forming a biaxially oriented nanocoinposite film can be carried out in a batch or a continuous mode. In one embodiment, the method is carried out as a batch process wherein the component polymer composition, filler and optional additives are supplied to the extruder and the film is isolated until the components are consumed. Alternatively, the method can be carried out as a continuous process wherein the component polymer composition, filler and optional additives are continuously fed to the extruder and the film is continuously isolated.

In another embodiment, the polymeric composition in powder form, pellet form, sheet form, or the like, is first dry blended with the nanoparticles and other optional fillers if desired in a Henschel or a roll mill, prior to being fed into the first extruder. In this way, the nanoparticles are introduced into the melt blending device in the form of a masterbatch. In such a process, the masterbatch can be introduced into the melt blending device downstream of the polymeric composition.

When a masterbatch is used, the nanoparticles are present in the masterbatch in an amount of about 1 to about 50 wt %, more particularly about 1 to about 40 wt %, even more particularly about 1 to about 20 wt % of the total weight of the masterbatch. Examples of polymeric compositions that can be used in masterbatches are polypropylene, polyetherimides, polyamides, polyesters, or the like, or a combination comprising at least one of the foregoing polymeric compositions.

In another embodiment relating to the use of masterbatches in polymeric blends, it is sometimes desirable to have the masterbatch comprising a polymeric composition that is the same as the polymeric composition that forms the continuous phase of the nanocomposite composition. In yet another embodiment relating to the use of masterbatches in polymeric blends, it can be desirable to have the masterbatch comprising a polymeric composition that is different in chemistry from other polymers that are used in the nanocomposite composition. In this case, the polymeric composition of the masterbatch will form the continuous phase in the blend.

The melt composition can further comprise a solvent. The solvent can be used as a viscosity modifier, or to facilitate the dispersion and/or suspension of nanoparticles. Liquid aprotic polar solvents such as propylene carbonate, ethylene carbonate, butyrolactone, acetonitrile, benzonitrile, nitromethane, nitrobenzene, sulfolane, dimethylformamide, N-methylpyrrolidone, o-dichlorobenzene, veratrole or the like, or a combination comprising at least one of the foregoing solvents can be used. Polar protic solvents such as water, methanol, acetonitrile, nitromethane, ethanol, propanol, isopropanol, butanol, or the like, or a combination comprising at least one of the foregoing polar protic solvents can be used. Other non-polar solvents such benzene, toluene, methylene chloride, carbon tetrachloride, hexane, diethyl ether, tetrahydrofuran, or the like, or a combination comprising at least one of the foregoing solvents can also be used if desired. Co-solvents comprising at least one aprotic polar solvent and at least one non-polar solvent can also be used. In one embodiment, the solvent is xylene or N-methylpyrrolidone.

In another embodiment the nanocomposite composition comprising the polymeric composition and the nanoparticles can be subject to multiple blending and forming steps if desirable. For example, the nanocomposite composition can first be formed and extruded into pellets. The pellets can then be fed into a second extruder for mixing with additional components before undergoing a blowing process to form an oriented film.

In another embodiment the disclosed method of forming a biaxially oriented nanocomposite film further comprises the step of annealing the blown film, also called crystallization. Annealing is generally accomplished post orienting, and is performed at temperatures between about 45° C. and about 140° C.

The bulk nanocomposite and the corresponding biaxially oriented nanocomposite films have advantages over the unfilled polymeric composition and corresponding films. In one embodiment, the nanocomposite has a tensile modulus at least comparable to the unfilled polymer composition, and an energy at break that is comparable to or improved relative to the unfilled polymer composition (extruded samples taken before blowing). The corresponding blown film has a breakdown strength of at least 300 Volts/micrometer (V/micrometer), more particularly at least 450 V/micrometer, and most particularly at least 500 V/micrometer.

An extruded sample of the nanocomposite when compression molded into a thin film has an increased corona resistance compared to a compression molded film of the unfilled polymer composition. In one embodiment, the nanocomposite has a corona resistance of 1-12 hours to an applied potential of 512 volts.

In another embodiment, the nanocomposite composition also has an impact strength of greater than or equal to the un-filled polymer composition. More particularly, the impact strength is greater than 5 kJ/m², even more particularly greater than 10 kJ/m², still more particularly greater than 15 kJ/m², and most particularly greater than 20 kJ/m².

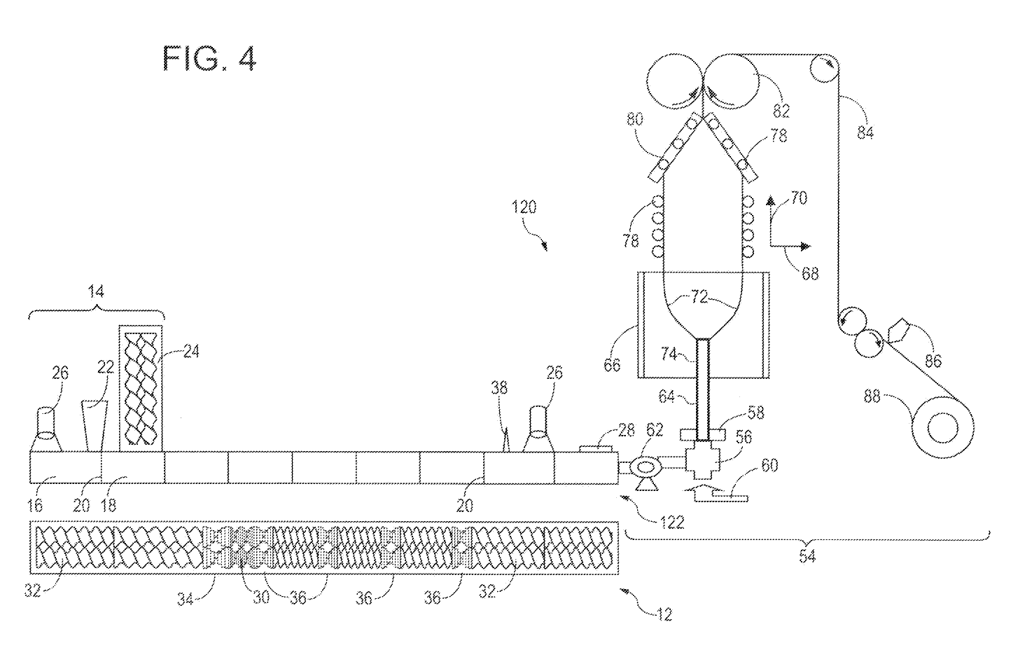

In one embodiment of the disclosed method, the mixing step to form the nanocomposite and the extrusion step to form the molten tube are performed by an extruder linked to a film blowing apparatus. This is schematically represented as system 120 in FIG. 4. In this embodiment, the polymer composition, nano-filler and any other optional additives are introduced via side feeder 24 and/or hopper 22 of extruder 122, where they are mixed to form a molten nanocomposite. Optional pump 62 linked to extruder 122 provides a more constant flow of the molten nanocomposite. The molten nanocomposite is forced through spiral mandrel die 56 of film blowing apparatus 54 to form a molten tube comprising the nanocomposite. In one embodiment, the extruder 122 comprises twin screws 12. In one embodiment cooling ring 58 cools the molten tube to form a rigid tube 64, which is reheated by heating oven 66 to form softened tube 74. Softened tube 74 is then expanded biaxially to form bubble 72 as previously described for FIG. 2. In another embodiment (not shown), cooling ring 58 adjusts the temperature of the molten tube emerging from the spiral mandrel die 56 to form a softened tube 74 capable of expansion into a bubble without additional heating, in accordance with the process previously described for FIG. 3.

Also disclosed is a biaxially oriented nanocomposite film formed by the process of mixing a nano-filler and a polymer composition to form a nanocomposite; extruding the nanocomposite as a melt to form a molten tube; expanding the tube biaxially by means of mechanical force and air pressure to form a bubble; and collapsing the bubble to form at least one sheet of the biaxially oriented nanocomposite film; wherein the biaxially oriented nanocomposite film has a breakdown strength of at least 300 V/micrometer. In one embodiment, the biaxially oriented nanocomposite film has a breakdown strength greater than or equal to 450 V/micrometer. In one embodiment, the biaxially oriented nanocomposite film has a breakdown strength greater than or equal to 500 V/micrometer. In one embodiment, the biaxially oriented nanocomposite film has an increased corona resistance compared to a biaxially oriented blown film without nano-filler. In one embodiment, the nano-filler is present in an amount of 1.0 to 10 weight percent, and more particularly 1.0 to 8.0 weight percent, based on total weight of the nanocomposite.

Also disclosed are articles comprising the biaxially oriented nanocomposite films such as spark plug caps, capacitors, high temperature identification labels, release films industrial membranes, insulation, flexible circuit board, defibrillators, or other articles.

The following examples, which are meant to be non-limiting, illustrate compositions and methods of manufacturing of some of the various embodiments of the nanocomposite compositions and the methods of manufacture described herein.

### EXAMPLES

The following process was designed specifically for the incorporation of nano-fillers into thermoplastics (metering of components, melting of the polymer, dispersion of the filler into the melt). The extruder screw configuration maximizes mixing, minimizes viscous dissipation (low melt T, short residence time). It has been observed that under conditions of high melt temperature, high screw speeds, and long residence times, the molecular weight of polypropylene (PP) degrades rendering its viscosity too low for blown film applications. Polypropylene (PP), in the form of pellets, and nano-filler, a powder, were not pre-mixed, but added separately. PP and nano-filler were added to a twin-screw side feeder using two separate loss-in-weight feeders. PP and nano-filler were not dried prior to compounding (were used as received). The extruder barrel temperature was set at about 180-190° C. Two levels of filler were used: 3 and 6 weight percent (wt. % or wt %). Nano-fillers: Cabosil TS530 HMDZ-treated fumed silica and Nanotek 40 nanometer Al₂O₃ (32-40 m²/g, Stock# 44932, Lot# 115R004). Comparison example 1 (C-1), 09212006-1, was the polypropylene polymer control that was run through the extruder without nano-filler.

Extruder.

The first extruder was a 25 mm diameter twin screw extruder having 9 barrels (L/D=36), each barrel is 100 mm long and 25 mm in diameter. An atmospheric vent was located in barrel 8. The extruder die plate for isolation and pelletization of the nanocomposite had 4 holes. The first extruder contains an upstream kneading section to melt the polymer, and three downstream mixing sections to uniformly incorporate the nano-filler into the molten polymer. A twin screw side feeder was attached to the first extruder at barrel number two. Table 1 lists the screw elements used in the design of the extruder. The symbols RHKB and NKB in Table 1 are used to designate the so-called right-handed and neutral kneading blocks, respectively, with the number accompanying this designation characterizing the length of the element in millimeters. The elements designated with a combination of two numbers represent two-lobe conveying elements, with the first number giving the pitch of the element and the second number its length. The number in parenthesis following the symbol designating either a kneading block or a conveying element represents the number of that element used in that particular section of the screw. With this nomenclature, 12RHKB(3), for example, represents three adjacent 12 mm-long right-handed kneading blocks, and 24/12 represents a single 12 mm-long two-lobe conveying element having a pitch equal to 24 mm.

TABLE
136/18SKN, 36/36SK(5), 36/18SKN, 36/18, 24/24, 36RHKB, 24RHKB,
24NKB, 12RHKB(3), 36/18, 24/24, 16/16, 12RHKB(3), 12NKB, 36/18,
24/24, 16/16, 12RHKB(3), 12NKB, 36/18, 24/24, 16/16, 12RHKB(3),
12NKB, 36/18, 36/36(4), 24/24(3), 16/16

Example C-1 to C-3 (09212006-1 to -3), Ex-1 and Ex-2 (09212006-4 to -5). Extrusion only experiment.

C-1 was a control sample of polypropylene used as received, run through the extruder.

In examples C-2, C-3, and Ex-1, polypropylene pellets and silica powder or alumina powder were fed into the side feeder separately using two loss-in-weight feeders at barrel two. A second atmospheric vent was located in barrel one.

In Ex-2 the polypropylene pellets were fed into barrel one and the nano-filler (silica) was fed into the side feeder at extruder barrel two. Otherwise, silica flowed out of the vent in barrel one when fed with polypropylene into the side feeder. One atmospheric vent was used at barrel eight.

The extruder conditions for C-1 to C-3 (09212006-1 to -3) and Ex-1 to Ex-2 (09212006-4 to -5) are listed in Tables 2A and 2B.

TABLE 2A

| | | Polymer | Filler | | Die Melt | Screw | Die |
|---|---|---|---|---|---|---|---|
| | | Feed Rate | Feed Rate | Torque | Temp | Speed | Pressure |
| | Condition # | (kg/hr) | (kg/hr) | (%) | (° C.) | (rpm) | (MPa) |
| C-1 | 09212006-1 | 22 | 0 | 60 | 212 | 500 | 0.91 |
| C-2 | 09212006-2 | 22 | 0.68 | 64 | 214 | 500 | 1.04 |
| C-3 | 09212006-3 | 21.3 | 1.36 | 59 | 215 | 500 | 0.85 |
| Ex-1 | 09212006-4 | 22 | 0.68 | 62 | 213 | 500 | 0.97 |
| Ex-2 | 09212006-5 | 14.2 | 0.91 | 47 | 211 | 500 | 0.84 |

TABLE 2B

| | | | Filler | Filler |
|---|---|---|---|---|
| | | Actual Barrel | Type | Loading |
| | Condition # | Temperatures (° C.) | (powder) | (wt %) |
| C-1 | 09212006-1 | 159/197/185/197/180/190 | None | 0 |
| C-2 | 09212006-2 | 158/196/192/197/180/190 | Alumina | 3 |
| C-3 | 09212006-3 | 159/194/190/197/180/191 | Alumina | 6 |
| Ex-1 | 09212006-4 | 141/189/181/192/176/201 | Silica | 3 |
| Ex-2 | 09212006-5 | 149/189/181/192/180/190 | Silica | 6 |

The complex viscosity (Pa-sec) at T=190° C. of each of the five samples was similar in the frequency range of 0.1 to 400 rad/sec, indicating the extrusion conditions did not degrade the molecular weight of the polypropylene. For example, the complex viscosity at 0.25 rad/sec ranged from 9470.33 to 10135.5 Pa-sec in the five samples. The storage modulus (Pa) at 6.96% strain ranged from 5637.16 to 6205.88 in the five samples. In particular, the rheological properties (viscosity, modulus) of two PP control samples (one extruded, C-1, and another non-extruded) can be considered to be the same, and within error associated with the technique for measuring them.

Table 3 lists the breakdown voltage in KV at ambient temperature versus thickness in micrometers for compression molded samples made from C1-C3, Ex-1 and Ex-2.

TABLE 3

| | | Breakdown Voltage | |
|---|---|---|---|
| | | at ambient temp. | |
| | Composition | KV/thickness | |
| C-1 | PP only | 10-20 | KV/20-30 micrometers |
| C-2 | PP + 3 wt % alumina | 1-6 | KV/25-35 micrometers |
| C-3 | PP + 6 wt % alumina | 1-6 | KV/25-35 micrometers |
| Ex-1 | PP + 3 wt % silica | 10-20 | KV/20-35 micrometers. |
| Ex-2 | PP + 6 wt % silica | 10-20 | KV/25-35 micrometers. |

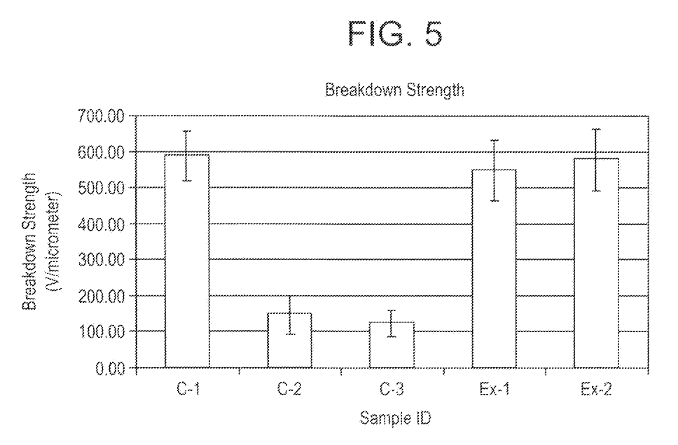

FIG. 5 is a bar chart showing the average breakdown strength (V/micrometer) normalized to 1 mil thickness with error limits of examples C-1 to C-3 and Ex-1 to Ex-2. The average (at least 15 samples) breakdown strength was 548 and 579 V/micrometer for Ex-1 and Ex-2 respectively, slightly lower than the breakdown strength (587 V/micrometer) of the polypropylene control sample C-1 having no nano-filler. The average breakdown strength of the alumina-containing samples C-2 and C-3 were 147 and 122 V/micrometer, respectively. One standard deviation of these measurements varied between 36 and 86 V/micrometer for the five conditions.

Corona resistance, Table 3, was measured at 3 kHz AC, rms=512 V (10 MV/m) in C-1, Ex-1 and Ex-2, and results were averaged over 4 samples. The samples were compression molded at 200° C. having a thickness of 50.8 micrometers (2 mil). The corona resistance of Ex-1 and Ex-2 both exceeded C-1, the extruded control sample of polypropylene having no nano-filler.

TABLE 3

| | Corona |
|---|---|
| | Resistance |
| | (hr) |
| C-1 | 1.97 |
| Ex-1 | 3.54 |
| Ex-2 | 11.63 |

Example Ex-3 to Ex-4. 90.7 kg (200 pound) scale-up of Ex-1 and Ex-2. First and second extruders.

Polypropylene was added to barrel one and nano-filler was added to the extruder barrel two of a first extruder using two loss-in-weight feeders. One vent was used in barrel eight. The polypropylene was BORCLEAN from Borealis. The nano-filler was Cabosil TS530 HMDZ-treated fumed silica. The extruder ran for 4-6 hours with no interruption. Two levels of nano-filler were used: 3 and 6 wt % (weight percent) based on total weight of the nanocomposite. Six samples were taken from each one of the 90.7 kg (200 lb.) batches prepared using each silica level. The extruder settings for the 3 AVt % nanocomposite are shown in Table 4.

TABLE 4
Ex-3. 3% silica, extruder conditions (six samples taken for one 200 lb batch)

| | Polymer | Filler | | Die Melt | Screw | Die | Actual Barrel |
|---|---|---|---|---|---|---|---|
| | Feed Rate | Feed Rate | Torque | Temp | Speed | pressure | Temperatures |
| Condition # | (kg/hr) | (kg/hr) | (%) | (° C.) | (rpm) | (MPa) | (° C.) |
| 10122006-1 | 22.1 | 0.72 | 58 | 215 | 506 | 1.09 | 150/189/190/ |
| | | | | | | | 196/190/195 |
| 10122006-2 | 21.7 | 0.70 | 62 | 214 | 502 | 0.98 | 150/188/190/ |
| | | | | | | | 196/190/195 |
| 10122006-3 | 22.0 | 0.71 | 62 | 214 | 505 | 1.05 | 150/188/190/ |
| | | | | | | | 196/190/195 |
| 10122006-4 | 22.0 | 0.67 | 63 | 215 | 507 | 0.94 | 150/188/190/ |
| | | | | | | | 197/190/195 |
| 10122006-5 | 22.2 | 0.67 | 63 | 215 | 503 | 0.92 | 150/188/190/ |
| | | | | | | | 190/190/195 |
| 10122006-6 | 21.9 | 0.66 | 63 | 215 | 501 | 1.09 | 150/188/190/ |
| | | | | | | | 197/190/195 |
| Set Values | 22.0 | 0.68 | | | | | |

The extruder settings for the 6 wt % nanocomposite are listed in Table 5. Again six samples were taken for one 90.7 kg (200 lb) batch.

TABLE 5
Ex-4. 6% silica, extruder conditions (six samples
taken for one 90.7 kg (200 lb batch))

| | Polymer | Filler | | Die Melt | Screw | Die | Actual |
|---|---|---|---|---|---|---|---|
| | Feed Rate | Feed Rate | Torque | Temp | Speed | Pressure | Barrel Temp |
| Condition # | (kg/hr) | (kg/hr) | (%) | (° C.) | (rpm) | (MPa) | (° C.) |
| 10132006-1 | 14.24 | 0.93 | 46 | 213 | 554 | 0.84 | 150/192/190/ |
| | | | | | | | 197/180/190 |
| 10132006-2 | 14.12 | 0.87 | 44 | 214 | 551 | 0.79 | 150/191/190/ |
| | | | | | | | 196/180/190 |
| 10132006-3 | 14.34 | 0.87 | 46 | 214 | 554 | 0.88 | 150/189/191/ |
| | | | | | | | 196/180/190 |
| 10132006-4 | 14.17 | 0.89 | 46 | 214 | 551 | 0.66 | 150/191/190/ |
| | | | | | | | 196/180/190 |
| 10132006-5 | 14.12 | 0.93 | 49 | 214 | 551 | 0.75 | 150/188/190/ |
| | | | | | | | 196/180/190 |
| 10132006-6 | 14.18 | 0.93 | 46 | 214 | 552 | 0.86 | 150/187/190/ |
| | | | | | | | 195/180/190 |
| Set Values | 14.21 | 0.91 | | | | | |

The nano-filler loading was confirmed by thermogravimetric analysis.

### Blown Films-Expt #1

The nanocomposites in Ex-3 and Ex4 were blown into biaxially oriented films using a second extruder (film extruder). The film extruder produced a parison (tube) of about 5.08 centimeters (2 inches) in diameter and about 500 micrometers thickness at about 3.81 meters/min (12.5 ft/min). Table 5A lists tensile and modulus properties (average of at least three samples) taken from the parisons before blowing the films, demonstrating that the modulus and tensile properties of the nanocomposites are comparable to or higher than a control, C-X, a commercial polypropylene that was not run through the compounding extruder and contained no nano-filler. C-X passes quality control for use in manufacturing of unfilled biaxially oriented polypropylene films for capacitor applications.

TABLE 5A
Measurements taken on samples from the parison (tube) prior
to blowing films. Average of at least three samples.

| | | | | Tensile | Tensile | Tensile | Tensile | |
|---|---|---|---|---|---|---|---|---|
| | | | Young's | Strain | Stress | Stress | Strain | Energy |
| | | | Modulus | at Yield | at Yield | at Break | at Break | at Break |
| | Condition # | | (MPa) | (%) | (MPa) | (MPa) | (%) | (J) |
| C-X | 10242006PP-1 | PP | 504 | 10.7 | 14.97 | 12.75 | 743.7 | 31.5 |
| | | Control, | | | | | | |
| | | no filler | | | | | | |
| Ex-3 | 10242006PP-2 | PP w/ | 514 | 11.9 | 15.84 | 15.41 | 836.7 | 42.0 |
| | | 3% Silica | | | | | | |
| Ex-4 | 10242006PP-3 | PP w/ | 483 | 11.2 | 15.62 | 13.56 | 739.0 | 32.3 |
| | | 6% Silica | | | | | | |

The biaxial extension mechanism stretches this tube into a double sheet film at about 22.6 meters/min (74 ft/min), at a rate of about 40 pounds of polymer an hour. A polypropylene control was also run as a reference. The three materials were run under similar process conditions. The extruder barrel temperatures were maintained between 213° C. (415° F.) and 227° C. (440° F.), the adapter temperatures at between 188° C. (370° F.) and 210° C. (410° F.) and the spiral mandrel annular die at about 188° C. (370° F.). The pressure inside the extruder was about 11.7 MPa (1700 psi) (a screen pack was not used to trap particulate contaminants in the materials). The extruder was operated at 18 rpm screw speed. The temperature of the oven where the parison tube was inflated was about 538° C. (1000° F.) and the pressure inside the bubble was about 0.12 MPa (17 psi). These process conditions produced a bubble (double sheet film) of about 37.1 centimeters (14.6 inches) in diameter and 15-20 micrometers in thickness.

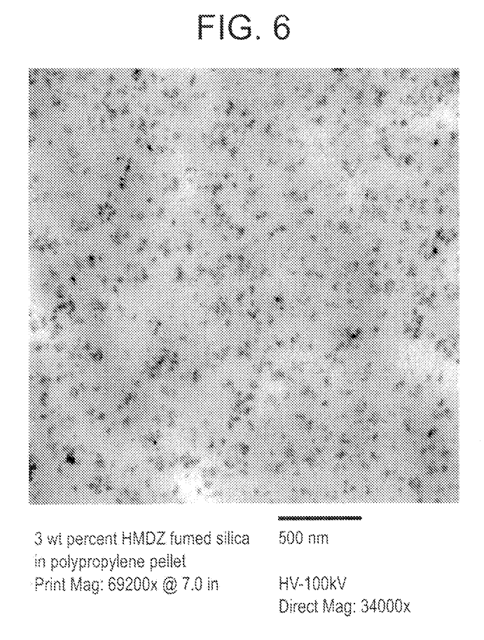

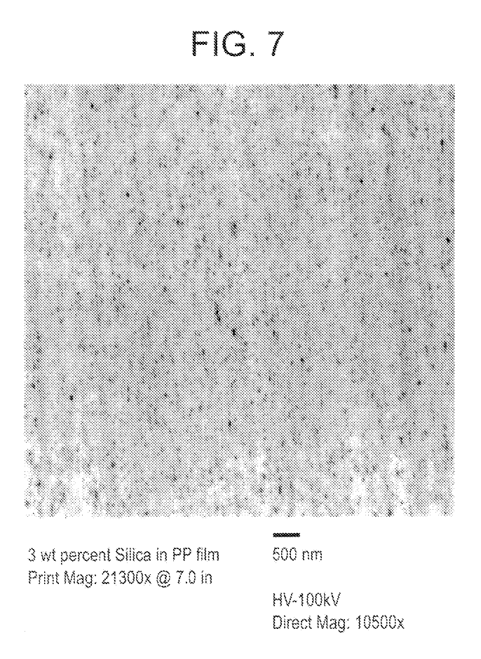

The nano-filler morphology in starting material pellets was conserved in the blown films as shown in FIG. 6. Transmission electron micrographs showed alignment of the nano-filler particles in the machine direction, as shown in FIG. 7.

The first DC breakdown strength test used a 6.35 millimeter (0.25 inch) ball electrode, oil immersion, and 500 V/s, DC, positive. A control sample blown film of polypropylene having no nano-filler had an average breakdown strength of 10.5 KVDC (15 samples), a blown film of Ex-3 (3 wt % silica) had an average breakdown strength of 11.5 KVDC (16 samples), and a blown film of Ex-4 (6 wt % silica) had an average breakdown strength of about 10.8 KVDC (14 samples).

The second DC breakdown strength test used dry film samples, metallized polypropylene films as electrodes, a mask size of 1 cm by 2 cm, and 480 V/s, DC positive. A control sample blown film of polypropylene having no nano-filler had an average breakdown strength of 8.68 KVDC (5 samples), a blown film of Ex-3 (3 wt % silica) had an average breakdown strength of 9.9 KVDC (5 samples), and a blown film of Ex-4 (6 wt % silica) had an average breakdown strength of about 10.36 KVDC (5 samples). The film thicknesses averaged 16 micrometers. The standard deviation of the measurements performed on the composite samples was larger than that for the unfilled PP control.

Blown Films—Expt #2, C-5 to C-7, Ex-5 and Ex-6.

Blown films were made as in the previous examples. Table 6 compares control samples having no nano-filler to samples having HMDZ treated fumed silica. Measurements were performed in silicone oil. Samples were taken from rolls. Values are averages of several samples. Films were approximately 13-18 micrometers thick, with the standard deviations of the measurements below 5% of the mean.

TABLE 6
C-5 to C-7 and Ex-5 to Ex-6.

| | | | Average |
|---|---|---|---|
| | | | breakdown |
| | | | strength |
| | Condition# | | (VDC/micrometer) |
| C-5 | 05072007-1 | PP pellets, no | 797 |
| | | nano-filler, no | |
| | | melt filter | |
| C-6 | 05072007-2 | PP extruded | 809 |
| | | pellets, no | |
| | | nano-filler, no | |
| | | melt filter | |
| C-7 | 05072007-3 | PP pellets, no | 791 |
| | | nano-filler, with | |
| | | melt filter | |
| Ex-5 | 05072007-4 | 3 wt % HMDZ | 761 |
| | | coated fumed | |
| | | Silica In PP | |
| Ex-6 | 05072007-5 | 6 wt % HMDZ | 678 |
| | | coated fumed | |
| | | Silica In PP | |

Table 7 shows the conditions used to prepare the above nanocomposite blown films.

TABLE 7

| | C-5 | Ex-5 | Ex-6 |
|---|---|---|---|
| Barrel Temperatures (° C.) | | | |
| Barrel #1 Set/Read | 227/227 | 227/227 | 227/227 |
| Barrel #2 Set/Read | 227/226 | 227/229 | 227/226 |
| Barrel #3 Set/Read | 213/213 | 213/213 | 213/213 |
| Adapter Temperatures (° C.) | | | |
| Adapter #1 Set/Read | 207/207 | 207/207 | 207/207 |
| Adapter #2 Set/Read | 190/190 | 187/187 | 187/187 |
| Adapter #3 Set/Read | 190/190 | 187/188 | 187/187 |
| Die Temperature (° C.) | 189/190 | 187/187 | 187/187 |
| Set/Read | | | |
| Barrel Pressure (MPa) | 11.2 | 11.1 | 11.0 |
| Extruder Motor (amp/volt) | 12/55 | 15/50 | |
| Tube ADV. (fpm) | 12.5/ | 12.5/ | 12.5/ |
| Screw Speed (rpm) | 16 | 16 | 16 |
| Mandrel Quench | | | |
| Water Pressure In (MPa) | 0.40 | 0.40 | 0.39 |
| Water Temperature In (° C.) | 15.6 | 16.7 | 16.7 |
| Bubble Conditions | | | |
| Oven Temperature | 527/ | 516/18.50 | /18.90 |
| (° C./kvolt) | | | |
| Bubble Pressure (MPA) | 0.16 | | |
| Take-up speed (fpm) | 74 | | 74 |
| | CONTROL | 3% SILICA | 6% SILICA |

### Blown Films—Expt #3, C-8 to C-9 (06272007PP-1 and -2), Ex-7 and Ex-8 (06272007PP-3 and -4).

Blown films were also prepared on two lines at the smaller, laboratory scale. The film thickness was approximately 20 micrometers, and 200 meter rolls were collected as unslit flattened tubes. The conditions used on the smaller of the two blown film laboratory lines are shown in Tables 8 and 9 and the film dimensions are shown in Table 9.

TABLE 8
C-8 to C-9 (06272007PP-1 and -2, respectively) and Ex-7 to Ex-8
(06272007PP-3 and -4 respectively). 3 and 6 wt % silica

| | | | Extruder Temperatures | | | |
|---|---|---|---|---|---|---|
| | | | Set/Actual (° C.) | | | |
| | Condition # | | Zone 1 | Zone 2 | Zone 3 | Zone 4 |
| C-8 | 06272007PP-1 | PP Control, | 30/26 | 227/227 | 227/227 | 220/220 |
| | | no silica | | | | |
| C-9 | 06272007PP-2 | PP extruded | 30/28 | 227/227 | 227/227 | 220/220 |
| | | Control, no | | | | |
| | | silica | | | | |
| Ex-7 | 06272007PP-3 | PP w/3% | 30/29 | 227/227 | 227/227 | 220/220 |
| | | silica | | | | |
| Ex-8 | 06272007PP-4 | PP w/6% | 30/29 | 227/227 | 227/227 | 220/220 |
| | | silica | | | | |

| | | | Adapter | | | |
|---|---|---|---|---|---|---|
| | | | Temp | Die Temp | Melt | Melt |
| | | | Set/Actual | Set/Actual | Temp | Pressure |
| | Condition # | | (° C.) | (° C.) | (° C.) | (Bar) |
| C-8 | 06272007PP-1 | PP Control, | 220/220 | 215/214 | 193 | 130 |
| | | no silica | | | | |
| C-9 | 06272007PP-2 | PP extruded | 220/220 | 215/215 | 194 | 131 |
| | | Control, no | | | | |
| | | silica | | | | |
| Ex-7 | 06272007PP-3 | PP w/3% | 220/220 | 215/216 | 194 | 129 |
| | | silica | | | | |
| Ex-8 | 06272007PP-4 | PP w/6% | 220/220 | 215/215 | 194 | 131 |
| | | silica | | | | |

TABLE 9
C-8 to C-9 (06272007PP-1 and -2 respectively) and Ex-7 to Ex-8
(06272007PP-3 and -4 respectively). 3 and 6 wt % silica

| | | | | NANO-BOPP FILM DIMENSIONS | | | |
|---|---|---|---|---|---|---|---|
| | | Screw | Motor | Nominal Film | Nominal | Nominal | |
| | | Speed | Current | Thickness | Film Width* | Film Length | |
| | Condition # | (rpm) | (A) | (micrometer) | (mm) | (m) | Material |
| C-8 | 06272007PP-1 | 65 | 2.3 | 20 | 115 | 200 | PP CONTROL |
| C-9 | 06272007PP-2 | 65 | 2.3 | 20 | 115 | 200 | PP EXTRUDED |
| Ex-7 | 06272007PP-3 | 65 | 2.4 | 20 | 115 | 200 | PP w/3% |
| | | | | | | | SILICA |
| Ex-8 | 06272007PP-4 | 65 | 2.5 | 20 | 115 | 200 | PP w/6% |
| | | | | | | | SILICA |

*the width of the flattened tube (double sheet)

Table 10 lists the breakdown strengths of C-8 to C-9 (06272007PP-1 and -2) and Ex-7 to Ex-8 (06272007PP-3 and -4), as an average value of at least 20 measurements.

TABLE 10
C-8 to C-9 and Ex-7 to Ex-8. Laboratory scale blown film process

| | | | Average |
|---|---|---|---|
| | | | breakdown |
| | | | strength |
| | Condition # | | (VDC/micrometer) |
| C-8 | 06272007PP-1 | PP control, no | 691 |
| | | nano-filler | |
| C-9 | 06272007PP-2 | extruded PP, no | 596 |
| | | nano-filler | |
| Ex-7 | 06272007PP-3 | 3 wt % HMDZ | 635 |
| | | coated fumed | |
| | | Silica In PP | |
| Ex-8 | 06272007PP-4 | 6 wt % HMDZ | 606 |
| | | coated fumed | |
| | | Silica In PP | |

Blown Films—Expt #4, C-10 (06292007PP-1), Ex-9 and Ex-10 (06292007PP-2 and -3 respectively).

Blown films were also prepared on a second laboratory-scale extrusion line. The materials used in Expt #4 were the same used in Expt #2 and Expt #3. The film thickness was approximately 10-15 micrometers and 400-500m rolls were collected as unslit flattened tubes in Ex-9 and Ex-10. The extruder conditions are shown in Table 11A and 11B and the film properties are shown in Table 12. Line speeds of 11.9, 20.5 and 29.8 m/min were all tested successfully.

TABLE 11A
C-10 (06292007PP-1) and Ex-9 to Ex-10 (06292007PP-2
and -3 respectively). 3 and 6 wt % silica

| | | | | | Adapter |
|---|---|---|---|---|---|
| | EXTRUDER TEMPERATURES | | | | Temperature |
| | SET/ACTUAL (° C.) | | | | Set/Actual |
| Condition # | Zone 1 | Zone 2 | Zone 3 | Zone 4 | (° C.) |
| 06292007PP-1 | 175/179 | 210/210 | 220/218 | 225/225 | 200/200 |
| 06292007PP-2b | 175/179 | 210/210 | 220/220 | 225/225 | 200/200 |
| 06292007PP-2e | 175/179 | 210/210 | 220/220 | 225/225 | 200/200 |
| 06292007PP-3b | 175/180 | 210/210 | 220/216 | 225/225 | 200/201 |
| 06292007PP-3m | 175/179 | 210/210 | 220/220 | 225/225 | 200/200 |
| 06292007PP-3e | 175/182 | 210/210 | 220/220 | 225/225 | 200/200 |

TABLE 11B

| | DIE TEMPERATURE | | | Melt | Melt |
|---|---|---|---|---|---|
| | SET/ACTUAL (° C.) | | | Temp | Pressure |
| Condition # | Zone 1 | Zone 2 | Zone 3 | (° C.) | (Bar)(*) |
| 06292007PP-1 | 200/200 | 200/201 | 190/198 | 213 | n/a |
| 06292007PP-2b | 200/201 | 200/201 | 190/198 | 215 | n/a |
| 06292007PP-2e | 200/201 | 200/202 | 190/197 | 215 | n/a |
| 06292007PP-3b | 200/201 | 200/202 | 190/197 | 216 | n/a |
| 06292007PP-3m | 200/200 | 200/200 | 190/191 | 215 | n/a |
| 06292007PP-3e | 200/200 | 200/201 | 190/195 | 216 | n/a |

(*)The Pressure transducer on the extruder was not working at the time of the experiment
Sample 06292007PP-2b was taken at the beginning of the run
Sample 06292007PP-2e was taken at the end of the run
Sample 06292007PP-3b was taken at the beginning of the run
Sample 06292007PP-3m was taken at the middle of the run
Sample 06292007PP-3e was taken at the end of the run

TABLE 12
C-10 (06292007PP-1) and Ex-9 (06292007PP-2b, -2e respectively), Ex-10
06292007PP-3b, -3m, and -3e respectively), “b”, “m” and “e” designate beginning,
middle and end of the run respectively. 3 and 6 wt % silica

| | | | | Nano-Bopp Film Dimensions | | | |
|---|---|---|---|---|---|---|---|
| | Screw | Motor | Take Off | Nominal | Nominal | Nominal | |
| | Speed | Current | Speed | Film Thickness | Film Width* | Film Length | |
| Condition # | (rpm) | (A) | (m/min) | (micrometers) | (mm) | (m) | Material |
| 06292007PP-1 | 75 | 4.8 | 11.8 | 10 to 20 | 310 | 200 | PP |
| | | | | | | | CONTROL |
| 06292007PP-2b | 74 | 5.2 | 11.9 | 10 to 20 | 310 | 200 | PP w/3% |
| | | | | | | | SILICA |
| 06292007PP-2e | 75 | 5.5 | 20.5 | 10 to 20 | 310 | 200 | PP w/3% |
| | | | | | | | SILICA |
| 06292007PP-3b | 74 | 5.4 | 11.6 | 10 to 20 | 310 | 150 | PP w/6% |
| | | | | | | | SILICA |
| 06292007PP-3m | 74 | 5.4 | 20.1 | 10 to 20 | 310 | 150 | PP w/6% |
| | | | | | | | SILICA |
| 06292007PP-3e | 90 | 5.3 | 29.8 | 10 to 20 | 310 | 150 | PP w/6% |
| | | | | | | | SILICA |

*width of flattened tube (double sheet), unslit

Table 13 lists the breakdown strengths of C-10 (06292007PP-1) and Ex-9 to Ex-10 (06292007PP-2 and -3 respectively).

TABLE 13
C-10 and Ex-9 to Ex-10. Average breakdown strength

| | | | Average | |
|---|---|---|---|---|
| | | | breakdown | Average |
| | | | strength | Film Thickness |
| | Condition # | | (VDC/micrometer) | (micrometer) |
| C-10 | 06292007PP-1 | PP control, no nano-filler | 409 | 18.5 |
| Ex-9 | 06292007PP-2 | 3 wt % HMDZ coated | 539 | 12.6 |
| | | fumed Silica In PP | | |
| Ex-10 | 06292007PP-3 | 6 wt % HMDZ coated | 488 | 10.6 |
| | | fumed Silica In PP | | |

The above examples illustrate that nanocomposites formed by extrusion have good mechanical properties and can be successfully blown to produce biaxially oriented films having breakdown strengths greater than 300 V/micrometer, and more particularly greater than 450 V/micrometer. The oriented films are attractive for electronic applications such as capacitors.

It is to be noted that the terms “first,” “second,” and the like as used herein do not denote any order, quantity, or importance, but rather are used to distinguish one element from another. The terms “a” and “an” do not denote a limitation of quantity, but rather denote the presence of at least one of the referenced item. The modifier “about” used in connection with a quantity is inclusive of the stated value and has the meaning dictated by the context (e.g., includes the degree of error associated with measurement of the particular quantity). It is to be noted that all ranges disclosed within this specification are inclusive and are independently combinable. All amounts, parts, ratios and percentages used herein are by weight unless otherwise specified.

While the invention has been described with reference to the embodiments thereof, it will be understood by those skilled in the art that various changes can be made and equivalents can be substituted for elements thereof without departing from the scope of the invention. In addition, many modifications can be made to adapt a particular situation or material to the teachings of the invention without departing from the essential scope thereof. Therefore, it is intended that the invention not be limited to the particular embodiments disclosed as the best mode contemplated for carrying out this invention, but that the invention will include all embodiments falling within the scope of the appended claims.

What is claimed is:

1. A method, comprising:
mixing a nano-filler and a polymer composition to form a nanocomposite;
extruding the nanocomposite as a melt through a spiral mandrel die to form a molten tube;
expanding the tube biaxially by means of mechanical force and air pressure to form a bubble; and
collapsing the bubble to form at least one sheet of a biaxially oriented nanocomposite film; wherein
the biaxially oriented nanocomposite film has a breakdown strength of at least 300 V/micrometer.

2. The method of claim 1, wherein the breakdown strength is at least 450 V/micrometer.

3. The method of claim 1, wherein mixing and extruding to form a molten tube are performed by an extruder linked to a film blowing apparatus.

4. The method of claim 1, wherein expanding the tube biaxially occurs in an oven above the spiral mandrel die.

5. The method of claim 1, wherein expanding the tube biaxially occurs as the tube emerges from the spiral mandrel die.

6. The method of claim 1, wherein the polymer composition comprises polypropylene and the nano-filler comprises fumed silica.

7. The method of claim 1, wherein the nano-filler comprises nano-particles having an average size in one characteristic dimension of 1 nanometer to 100 nanometers, and aggregates formed by the nano-particles have a size in one characteristic dimension of 2 nanometers to 1000 nanometers.

8. The method of claim 1, wherein a compression molded film made from the nanocomposite has an increased corona resistance compared to a compression molded film made from the unfilled polymer composition.

9. A biaxially oriented nanocomposite film formed by the process of:
mixing a nano-filler and a polymer composition to form a nanocomposite;
extruding the nanocomposite as a melt to form a molten tube;
expanding the tube biaxially by means of mechanical force and air pressure to form a bubble; and
collapsing the bubble to form at least one sheet of the biaxially oriented nanocomposite film; wherein
the biaxially oriented nanocomposite film has a breakdown strength of at least 300 V/micrometer.

10. The composition of claim 9, wherein the biaxially oriented nanocomposite film has a breakdown strength greater than or equal to 450 V/micrometer.

11. The composition of claim 9, wherein a compression molded film made from the nanocomposite has an increased corona resistance compared to a compression molded film made from the unfilled polymer composition.

12. The composition of claim 9, wherein the nano-filler is present in an amount of 1.0 to 10 weight percent based on total weight of the nanocomposite.

13. The composition of claim 9, wherein the nano-filler is present in an amount of 1.0 to 8.0 weight percent based on total weight of the nanocomposite.

14. The nanocomposite film of claim 9, wherein the polymer composition comprises a thermoplastic polymer selected from the group consisting of polyacetals, polyacrylics, polycarbonates, polyalkyds, polystyrenes, polyolefins, polyesters, polyamides, polyaramides, polyamideimides, polyarylates, polyurethanes, silicones, polyarylsulfones, polyethersulfones, polyphenylsulfones, polycarbonates, silicones, polycarbonate-polyorganosiloxanes, polyphenylene sulfides, polysulfones, polyimides, polyetherimides, polytetrafluoroethylenes, polyetherketones, polyether etherketones, polyether ketone ketones, polybenzoxazoles, polyoxadiazoles, polybenzothiazinophenothiazines, polybenzothiazoles, polypyrazinoquinoxalines, polypyromellitimides, polyquinoxalines, polybenzimidazoles, polyoxindoles, polyoxoisoindolines, polydioxoisoindolines, polytriazines, polypyridazines, polypiperazines, polypyridines, polypiperidines, polytriazoles, polypyrazoles, polycarboranes, polyoxabicyclononanes, polydibenzofurans, polyphthalides, polyacetals, polyanhydrides, polyvinyl ethers, polyvinyl thioethers, polyvinyl alcohols, polyvinyl ketones, polyvinyl halides, polyvinyl nitriles, polyvinyl esters, polysulfonates, polysulfides, polyth ioesters, polysulfones, polysulfonamides, polyureas, polyphosphazenes, polysilazanes, polypropylenes, polyethylenes, polyethylene terephthalates, polyvinylidene fluorides, polysiloxanes, and a combination comprising at least one of the foregoing thermoplastic polymers.

15. The nanocomposite film of claim 9, wherein the polymer composition comprises a material selected from the group consisting of polyetherimide, fluorenyl polyester (FPE), polyvinylidene fluoride, polyvinylidine fluoride-trifluoroethylene P(VDF-TrFE), polyvinylidene-tetrafluoroethylene copolymers P(VDF-TFE), polyvinylidine trifluoroethylene hexafluoropropylene copolymers P(VDF-TFE-HFE) and polyvinylidine hexafluoropropylene copolymers P(VDF-H FE), cyanoresins and a combination comprising at least one of the foregoing.

16. The nanocomposite film of claim 9, wherein the polymer composition comprises a thermosetting polymer.

17. The nanocomposite film of claim 9, wherein the nano-filler comprises a inorganic material selected from the group consisting of cerium oxide (ceria), magnesium oxide (magnesia), titanium oxide (titania), zinc oxide, silica, colloidal silica, dispersions of colloidal silica in solvent, precipitated silica, fumed silica, copper oxide, alumina, fumed alumina, calcium oxide (calcia), zirconium oxide (zirconia), niobium pentoxide (niobia), yttrium oxide (yttria), tantalum pentoxide (tantala), barium titanate, barium strontium titanate, strontium-doped lanthanum manganate, calcium copper titanate (CaCu₃Ti₄O₁₂), cadmium copper titanate (CdCu₃Ti₄O₁₂), lanthanum doped CaMnO₃, and (Li, Ti) doped NiO, and a combination comprising at least one of the foregoing inorganic oxides.

18. The nanocomposite film of claim 9, wherein the nano-filler has been surface treated.

19. The nanocomposite film of claim 9, wherein the nano-filler has been surface treated with a silane-coupling agent selected from the group consisting of tetramethylchlorosilane, hexadimethylenedisilazane, gamma-aminopropoxysi lane, and a combination comprising at least one of the foregoing silane-coupling agents.

20. The nanocomposite film of claim 9, wherein the nanocomposite melt further comprises an additive selected from the group consisting of antioxidant, carbon black, graphite, calcium carbonate, talc, mica, mold release agent, UV absorber, heat stabilizer, light stabilizer, lubricant, plasticizer, pigment, dye, colorant, anti-static agent, blowing agent, flame retardant, impact modifier, and a combination comprising at least of the foregoing additives.

21. The nanocomposite film of claim 9, wherein the polymer composition comprises polypropylene and the nano-filler comprises a fumed silica.

22. An article comprising the biaxially oriented nanocomposite film of claim 9.

23. The article of claim 22, wherein the article is a capacitor, a spark plug, high temperature identification label, release film, industrial membrane, insulation, flexible circuit board, or defibrillator.
